(19) United States
(12) Patent Application Publication
(10) Pub. No.: US 2004/0013443 A1
(43) Pub. Date: Jan. 22, 2004

(54) Image forming device

(75) Inventors: Toshiyuki Itoh, Kawasaki (JP); Yasuhiro Nozaki, Kawasaki (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: FUJI XEROX CO., LTD., Tokyo (JP)

(21) Appl. No.: 10/429,957

(22) Filed: May 6, 2003

Related U.S. Application Data
(63) Continuation of application No. PCT/JP00/07849, filed on Nov. 8, 2000.

(51) Int. Cl. G03G 15/02

(52) U.S. Cl. 399/100

(57) ABSTRACT

An image forming device has a charger including a charging wire and a wire cleaner for cleaning the charging wire. The wire cleaner has a pair of legs, and cleaning members are provided inside the legs to be able to squeeze the charging wire between them. A stub is provided on the outside of each leg, and the wire cleaner can rotate round the stub, with the result that the cleaning members can move between a regular position in which they are placed on two sides of the charging wire and a step-aside position in which they are farther from the charging wire than in the regular position.

### CROSS-REFERENCE TO RELATED APPLICATION

This application is a continuation application of PCT/JP00/07849, filed on Nov. 8, 2000, the contents being incorporated therein by reference.

### BACKGROUND OF THE INVENTION

1. Field of the Invention

The present invention relates to an image forming device of an electrophotographic system using a charging wire, such as a printer, facsimile or copying machine, and more particularly to an image forming device provided with a cleaner for cleaning the charging wire.

2. Description of the Related Art

In an image forming device of an electrophotographic system using a charging wire, toner or the like having flown out of the developer, the photosensitive drum or the cleaning unit may float and stick to the charging wire, fine dust or the like may come into the device from outside under the influence of the air current within, or pieces of paper, hair or the like may fall in when the printing unit is being handled and stick to the charging wire, inviting faulty or uneven charging and consequently faulty printing. Therefore, if any faulty printing has occurred, or after having printed a prescribed number of sheets, the charging wire should be cleaned.

Image forming devices equipped with a cleaner for the charging wire (wire cleaner) are disclosed in the Japanese Published Unexamined Patent Applications Nos. Hei 10-20626 and 10-326037. The wire cleaner is provided with two cleaning members, made of felt for instance, and the charging wire is cleaned by squeezing it between these cleaning members and moving them along the charging wire.

According to the prior art, the wire cleaner is formed separately from the charger, and when the wire cleaner is to be used, it is fitted to the charger. When the user uses the wire cleaner for cleaning, the user may not know where to fit the wire cleaner, or may have lost the cleaner. This would make it impossible to clean the charging wire and thereby pose an operational problem.

In view of this problem, according to the Japanese Published Unexamined Patent Application No. Hei 10-20626, a wire cleaner is built into the charger so that the wire cleaner can be used as required. In this case, when it is not in use (when the image forming device is in use), the wire cleaner remains stowed in the charger. If the wire cleaner is positioned in the charger when the wire cleaner is not in use, faulty discharging will arise in the area where the wire cleaner is positioned, inviting faulty printing. According to the Japanese Published Unexamined Patent Application No. Hei 10-20626 cited above, the charger is divided into a discharge area and a standby area, and the wire cleaner is positioned in the standby area when it is not in use, and printing is performed in the discharge area. Further a display is provided to indicate that the wire cleaner is positioned in the standby area.

The charging wire extends penetrating the discharge area and the standby area. Therefore, when the wire cleaner is not in use and positioned in the standby area, the cleaning members remain in continuous contact with the charging wire, and are compressed against each other. As a consequence, the cleaning members become quickly deteriorated and unable to perform adequate cleaning. Therefore, it is desirable for the cleaning members to be kept away from the charging wire when the wire cleaner is not in use.

Further, the division of the inside of the charger into the discharge area and the standby area entails a loss of the effectively usable length of the charger as much as it is occupied by the standby area. Moreover, the positioning of the wire cleaner in the standby area when it is not in use means the absence of discharging action in the standby area, with the result that discharging action in the part of the discharge area adjoining the standby area is reduced, making faulty printing more likely to occur.

### SUMMARY OF THE INVENTION

The present invention has been made to provide an image forming device with a built-in wire cleaner.

The invention has been made also to provide an image forming device free from early deterioration of the cleaning members of the wire cleaner, capable of fully utilizing the length of the charger and not susceptible to faulty printing because of the presence of the wire cleaner.

An image forming device according to the invention is provided with a frame, a photosensitive drum, a charger including a charging wire for electrically charging the photosensitive drum, an optical head for forming an electrostatic latent image on the photosensitive drum, a developer for developing the electrostatic latent image into a toner image, and a wire cleaner for cleaning the charging wire, wherein the wire cleaner is provided with a pair of cleaning members disposed to be able to squeeze the charging wire between them, and the wire cleaner is fitted to the charger to enable the cleaning members to move between a regular position in which they are placed on two sides of the charging wire and a step-aside position in which the cleaning members are farther from the charging wire than in the regular position.

In this configuration, the wire cleaner can shift along the charging wire in a state in which the charging wire is squeezed between the pair of cleaning members, and thereby clean the charging wire. The wire cleaner is in the regular position while cleaning the charging wire. The wire cleaner, when not in use, is placed in the step-aside position. Therefore, the wire cleaner, when not in use, does not affect the discharging action of the charger and give rise to faulty printing, and there will be no loss in the effectively usable length of the charger.

Preferably, the frame of the device should have an insertion area in which the wire cleaner is inserted into the frame and a shifting area in which the wire cleaner can shift along the charging wire. The cleaning members would be movable between a first position in which they are away from the charging wire and a second position in which they come into contact with the charging wire. The cleaning members would be in the first position when the wire cleaner is in the insertion area and in the second position when the wire cleaner is in the shifting area.

Preferably, the wire cleaner should be able to shift between the regular position and the step-aside position when the wire cleaner is in the insertion area.

Preferably, the wire cleaner should be substantially vertical to the charging wire when the wire cleaner is in the regular position and the body of the wire cleaner should be substantially parallel to the charging wire when it is in the step-aside position.

Preferably, the photosensitive drum, the charger and the developer should be integrated as a printing unit, and the frame should have guide portions which guide the wire cleaner to be able to be displaced from the regular position to the step-aside position when the printing unit is inserted into the frame.

### BRIEF DESCRIPTION OF THE DRAWINGS

The above-stated and other advantages and features of the present invention will become apparent from the following detailed description when taken in conjunction with the accompanying drawings, wherein:

FIG. 1 shows a schematic section of a printer, which is a preferred embodiment of the invention;

FIG. 2 shows a section of the drum unit of the printer shown in FIG. 1;

FIG. 3 shows a schematic plan of the drum unit fitted with a wire cleaner;

FIG. 4 shows a plan of a cleaner guide of a charger;

FIG. 5 shows a plan of the relationship among the photosensitive drum, the charger and the wire cleaner;

FIG. 6 shows a front view of the wire cleaner;

FIG. 7 shows a profile of the wire cleaner;

FIG. 8 shows a section of the drum unit in whose insertion area there is the wire cleaner;

FIG. 9 shows a section of the drum unit in whose shifting area there is the wire cleaner;

FIG. 10 shows a profile section of the drum unit wherein the wire cleaner is in its regular position;

FIG. 11 shows a profile section of the drum unit wherein the wire cleaner is in its step-aside position;

FIG. 12 shows a plan of the drum unit wherein the wire cleaner is in its step-aside position;

FIG. 13 illustrates how a printing unit is inserted into the frame of the device;

FIG. 14 illustrates how the wire cleaner rotates when the printing unit is inserted into the frame of the device;

FIG. 15 shows an enlarged sectional view of part of FIG. 10; and

FIG. 16 shows a plan of the cleaner guide and auxiliary guides of FIG. 15.

### DETAILED DESCRIPTION OF THE PREFERRED EMBODIMENT

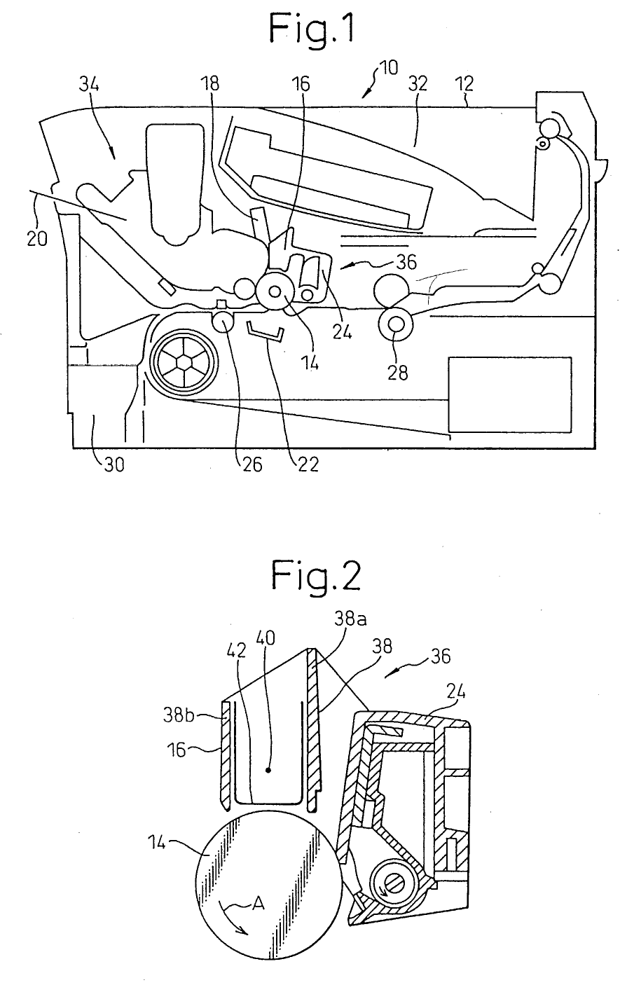

FIG. 1 shows a schematic section of a printer as an image forming device embodying the present invention. The applicability of the invention is not limited to the printer illustrated here, and the invention can as well be applied to other image forming devices including facsimiles and copying machines in addition to printers.

An image forming device 10 has a frame 12. A photosensitive drum 14, a pre-charger 16, an optical head (LED beam scanner) 18, a developer 20, a transfer element 22 and a toner cleaner 24 are arranged in the frame 12. Further, a paper feeding unit including a paper feed roller 26 and a fixer 28 made up of a pair of fixing rollers is arranged in the frame 12. Paper is fed from a paper feed cassette 30 to the photosensitive drum 14, passes between the photosensitive drum 14 and the transfer element 22, and is discharged to a stacker 32 through the fixer 28.

The photosensitive drum 14, the pre-charger 16, the developer 20 and the toner cleaner 24 are integrally assembled as a printing unit 34. Out of the constituent elements of the printing unit 34, the photosensitive drum 14, the pre-charger 16 and the toner cleaner 24 are integrally assembled as a drum unit 36.

FIG. 2 shows the drum unit 36. The pre-charger 16 has a charger frame 38, and a charging wire 40 and a metallic mesh 42 are arranged in the charger frame 38. Illustration of supporting parts for the charging wire 40 and the metallic mesh 42 is dispensed with. Supplying electricity to the charging wire 40 causes discharging to take place between the charging wire 40 and the metallic mesh 42, thereby charging the photosensitive drum 14 with electricity. The charger frame 38 includes two vertical walls 38a and 38b which are parallel to the charging wire 40 and extend in parallel to each other. The vertical wall 38a is higher than the vertical wall 38b.

The photosensitive drum 14 is driven to rotate in the direction of an arrow in FIG. 2. The surface of the photosensitive drum 14 is successively and evenly charged by the pre-charger 16. The optical head 18 arranged following the pre-charger 16 in the rotating direction of the photosensitive drum 14 writes an electrostatic latent image with an LED beam or a laser beam onto the charged area of the photosensitive drum 14. Thus the beam is intermittently lit on the basis of binary image data obtained from a computer, word processor or the like, and the electrostatic latent image is thereby written onto the charged area of the photosensitive drum 14 as a dot image.

The electrostatic latent image written onto the photosensitive drum 14 is electrostatically developed with a toner from the developer 20 as a charged toner image. Then the charged toner image is electrostatically transferred to a fed sheet of paper by the transfer element 22 positioned underneath the photosensitive drum 14. The sheet onto which the charged toner image has been transferred is directed to the fixer 28. Toner which was not transferred to the sheet is stuck to the surface of the photosensitive drum 14 having completed transferring the toner image to the sheet. This residual toner is removed by the toner cleaner 24.

The basic configuration and actions of the electrophotographic printer have been described so far. According to the present invention, a wire cleaner for cleaning the charging wire 40 is fitted to the printer 10.

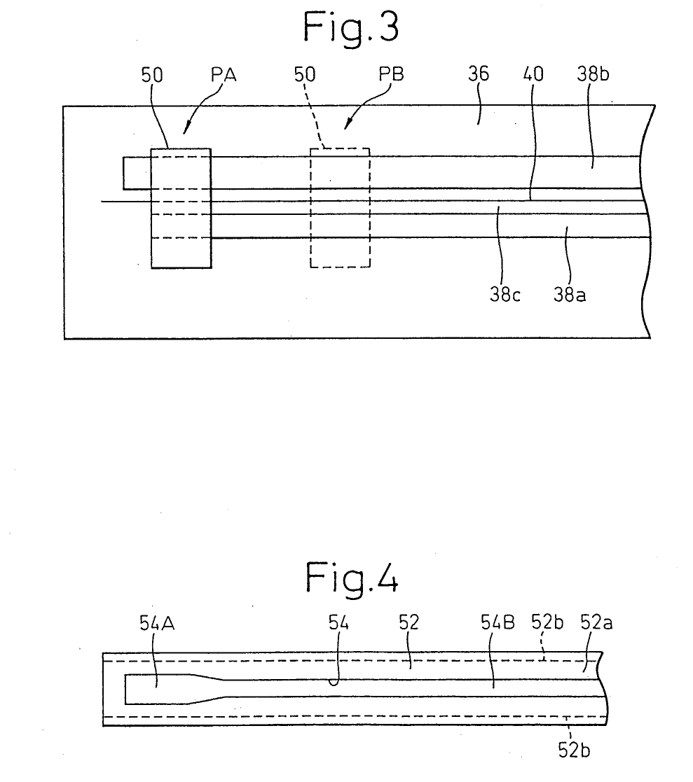

FIG. 3 shows a schematic plan of the drum unit 36 fitted with a wire cleaner 50. The top faces of the two vertical walls 38a and 38b described with reference to FIG. 2 look as if constituting the surface of the pre-charger frame 38 of the drum unit 36. The vertical walls 38a and 38b extend in parallel to the charging wire 40 and to each other, and a thin and long passage 38c is formed between the vertical walls 38a and 38b. When viewed from above, the charging wire 40 looks as if it were within this passage 38c (it has to be noted that the charging wire 40 is very thin). The wire cleaner 50 is fitted to the pre-charger 16 in this passage 38c.

FIG. 4 shows a plan of a cleaner guide 52 arranged in the charger frame 38. The cleaner guide 52 is arranged underneath the surface walls of the charger frame 38 shown in FIG. 3. The cleaner guide 52 is a plate member having a U section, arranged in parallel to the charging wire 40, and has a surface plate portion 52a and flange portions 52b hanging down from the two ends of the surface plate portion 52a. The surface plate portion 52a of the cleaner guide 52 has a substantially straight slit 54, which has a wider guide portion 54A and a narrower guide portion 54B. The wider guide portion 54A is in a limited area towards one end of the cleaner guide 52, while the narrower guide portion 54B long extends along the cleaner guide 52.

In FIG. 3, the wire cleaner 50 represented by solid lines is in an insertion area PA defined by the wider guide portion 54A of the slit 54 of the cleaner guide 52. The wire cleaner 50 represented by broken lines is in a shifting area PB defined by the narrower guide portion 54B of the slit 54 of the cleaner guide 52. In other words, the wire cleaner 50 is inserted into the pre-charger 16 in the insertion area PA, and is shiftable in the shifting area PB along the charging wire 40.

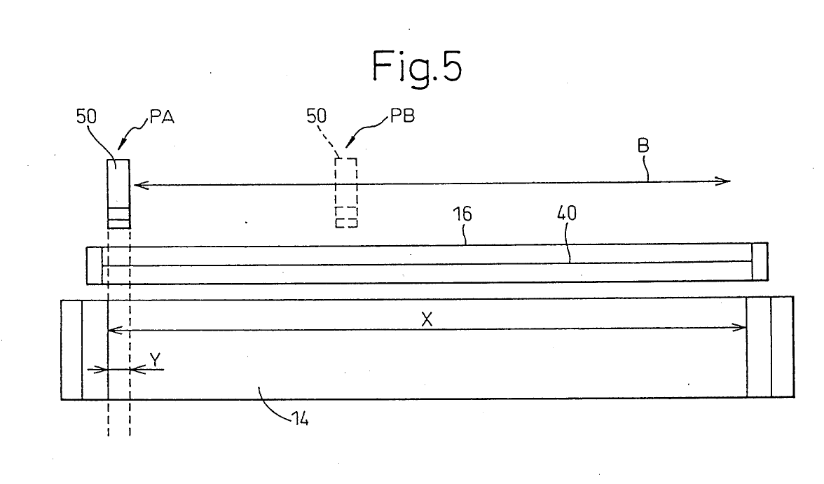

FIG. 5 shows a plan of the relationship among the photosensitive drum 14, the charger 16 and the wire cleaner 50. As in FIG. 3, the wire cleaner 50 represented by solid lines is in the insertion area PA while the wire cleaner 50 represented by broken lines is in the shifting area PB. The wire cleaner 50 is shiftable as indicated by an arrow B.

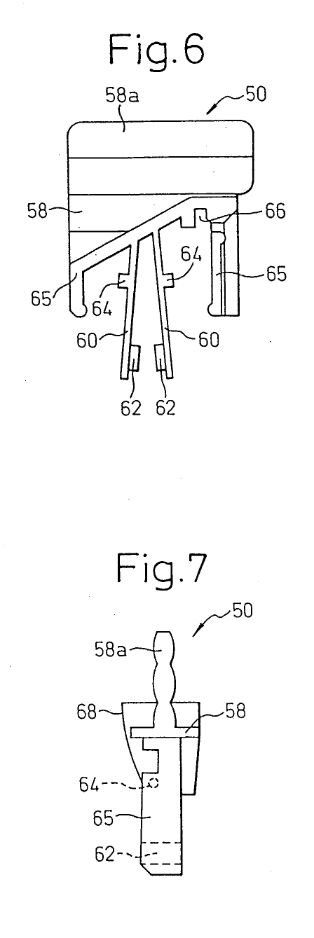

FIG. 6 shows a front view of the wire cleaner 50, and FIG. 7, a profile of the wire cleaner 50. The wire cleaner 50 has a body 58 made of a resin such as ABS, and the top portion of the body 58 constitutes a knob 58a. A pair of legs 60 extend downwards from near the center of the inclined bottom of the body 58. The legs 60 are farther from each other towards the tips than at their joints with the body 58. Cleaning members 62 are fitted to the inner sides of the tips of the legs 60. The cleaning members 62 are made of soft urethane foam, urethane foam coated with an abrasive, unwoven felt or the like, and so shaped that a pair of them can squeeze the charging wire 40 between them.

A stub 64 is provided on the outside of the middle section of each leg 60. A pair of sliding guides 65 extend downwards from the two ends of the inclined bottom of the body 58, and a sliding guide groove 66 is provided inside the sliding guide 65 of one of the legs 60. Further, the wire cleaner 50 has an slanted support 68.

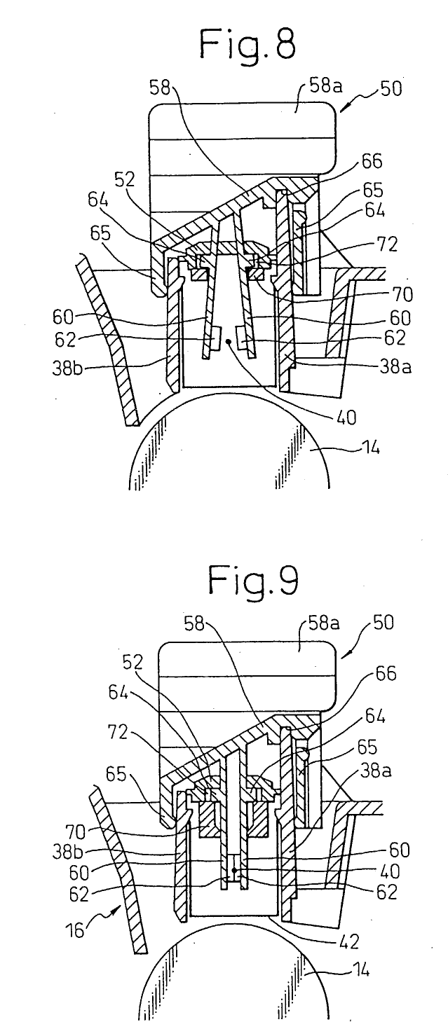

FIG. 8 shows the drum unit 36 in whose insertion area PA there is the wire cleaner 50, and FIG. 9, the drum unit 36 in whose shifting area PB there is the wire cleaner 50. The sliding guides 65 of the wire cleaner 50 are snapped in to be slidable along the outer faces of the vertical wall 38a and 38b of the charger frame 38, and the top of the taller vertical wall 38a is inserted slidably into the sliding guide groove 66. Therefore, the wire cleaner 50 is fitted to the charger frame 38 to be shiftable along the charging wire 40.

The charger frame 38 has a horizontal wall 70 between the vertical walls 38a and 38b, and the cleaner guide 52 shown in FIG. 4 is arranged over the horizontal wall 70 of the charger frame 38. In more detail, the flange portion 52b of the cleaner guide 52 is mounted over the horizontal wall 70, and the horizontal wall 70 and the cleaner guide 52 constitute an engaging groove 72. The stub 64 of the cleaner guide 52 is arranged in the engaging groove 72. When the wire cleaner 50 moves along the charging wire 40, the stub 64 slides in this engaging groove 72.

The horizontal wall 70 has a substantially straight slit matching the slit 54 of the cleaner guide 52. Thus, the width of the slit in the horizontal wall 70 varies to match the wider guide portion 54A and the narrower guide portion 54B of the slit 54 in the cleaner guide 52. The legs 60 of the wire cleaner 50 are inserted into the slit 54 in the cleaner guide 52 and the slit in the horizontal wall 70 underneath. When the legs 60 are positioned in the wider guide portion 54A, the pair of legs 60 become open, and the cleaning members 62 move away from the charging wire 40 (FIG. 8). When the legs 60 are positioned in the narrower guide portion 54B, the pair of legs 60 become closed, and the cleaning members 62 come into contact with the charging wire 40 (FIG. 9).

When the cleaner guide 52 is to be fitted to the pre-charger 16, the pair of legs 60, while the spacing between them is being narrowed, can be inserted into the wider guide portion 54A of the list 54 in the cleaner guide 52 and the slit in the horizontal wall 70 underneath. In this process, the stub 64 enters into the engaging groove 72 between the horizontal wall 70 and the cleaner guide 52. The pair of legs 60 cannot be directly inserted into the narrower guide portion 54B of the slit 54 in the cleaner guide 52, because the stub 64 cannot pass the narrower guide portion 54B of the slit 54 in the cleaner guide 52. Once the stub 64 enters into the engaging groove 72 between the horizontal wall 70 and the cleaner guide 52, the cleaner guide 52 can no longer be taken out of the pre-charger 16 but can slide along the charging wire 40. Thus, the wire cleaner 50 can be inserted into or taken out of the pre-charger 16 into the insertion area PA shown in FIG. 3, and can slide along the charging wire 40 in the shifting area PB shown in FIG. 3 without going off the cleaner guide 52.

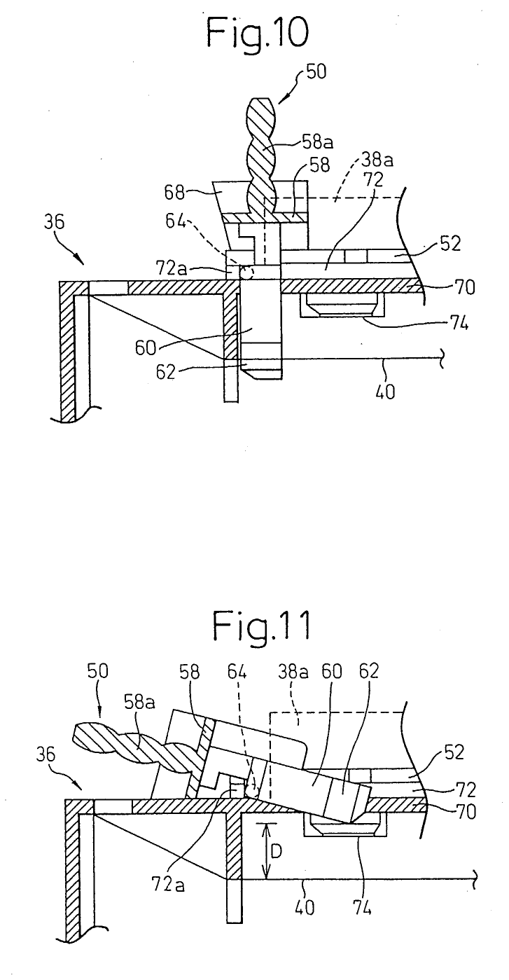

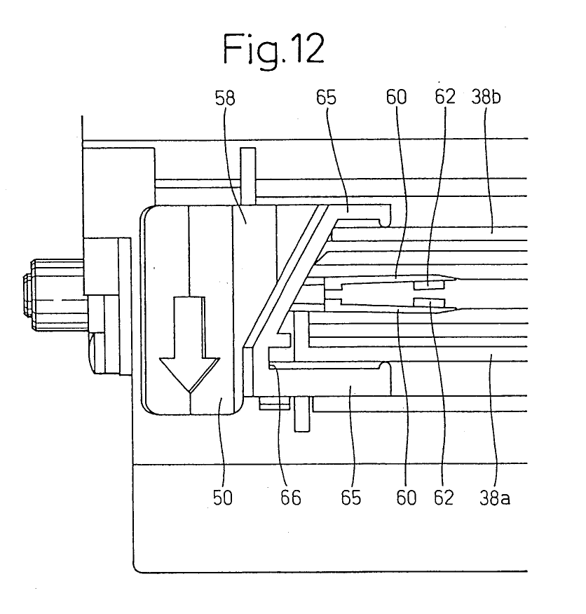

FIG. 10 shows a profile section of the drum unit 36 wherein the wire cleaner 50 is in its regular position; FIG. 11, a profile section of the drum unit 36 wherein the wire cleaner 50 is in its step-aside position; and FIG. 12, a plan of the drum unit 36 wherein the wire cleaner 50 is in its step-aside position.

Here, the regular position of the wire cleaner 50 means a position in which the cleaning members 62 are on the two sides of the charging wire 40. When the wire cleaner 50 is in its regular position, the wire cleaner 50 can move along the charging wire 40. Since the cleaning members 62 are on the two sides of the charging wire 40 in FIG. 8 and FIG. 9, the wire cleaner 50 is in its regular position. It has to be noted that in FIG. 8 the cleaning members 62 are not in contact with the charging wire 40 while in FIG. 9 the cleaning members 62 are in contact with the charging wire 40. Further, FIG. 10 shows the wire cleaner 50 in the position in FIG. 8.

The step-aside position of the wire cleaner 50 means a position in which its cleaning members 62 are farther from the charging wire 40 than when in the regular position. When the wire cleaner 50 is in its step-aside position, the wire cleaner 50 is away from the charging wire 40, and does not obstruct discharging between the charging wire 40 and the metallic mesh 42.

Slidable engagement of the sliding guide groove 66 of the wire cleaner 50 with the horizontal top of the vertical wall 38a of the pre-charger 16 (FIGS. 8 and 9) serves to keep the wire cleaner 50 in its vertical normal position. The vertical wall 38a is also shown in FIG. 10 and FIG. 11 in broken lines. The vertical wall 38a is terminated at an end of the insertion area PA and, when the wire cleaner 50 is inclined at the end of the insertion area PA, the sliding guide groove 66 of the wire cleaner 50 goes off the vertical wall 38a, and the stub 64 of the wire cleaner 50 comes into contact with an end wall 72a of the engaging groove 72 to enable the wire cleaner 50 to rotate, pivoting on the stub 64.

In FIG. 10 the wire cleaner 50 is in its vertical regular position, while in FIG. 11 the wire cleaner 50 is in its substantially horizontal step-aside position. In FIG. 10, the body 58 of the wire cleaner 50 protrudes from the surface of the drum unit 36 vertically to that surface, and the cleaning members 62 are positioned on the two sides of the charging wire 40. The knob 58a of the wire cleaner 50 can be manually handled thereby to shift the wire cleaner 50 along the charging wire 40.

In FIG. 11, the wire cleaner 50 is laid down, and the slanted support 68 is mounted on the surface of the pre-charger 16. As the wire cleaner 50 rotates round the stub 64, the position of the knob 58a is lowered, and the positions of the cleaning members 62 are raised. As a result, the cleaning members 62 go farther away from the charging wire 40 than when they are in the regular position.

In the step-aside position, the cleaning members 62 are sufficiently away from the charging wire 40 not to affect the discharging action of the charging wire 40. In a preferable step-aside position, the distance D between the cleaning members 62 and the charging wire 40 is greater than the distance d between the charging wire 40 and the metallic mesh 42, thereby preventing the cleaning members 62 from affecting the discharging action between the charging wire 40 and the metallic mesh 42.

In FIG. 5, the wire cleaner 50 is in the insertion area PA, where the cleaning members 62 are not in contact with the charging wire 40 (FIG. 8). The wire cleaner 50 is in its regular position, and the cleaning members 62 are on the two sides of the charging wire 40. In other words, the cleaning members 62 are positioned between the charging wire 40 and the metallic mesh 42. If the printer 10 were operated in a state in which the wire cleaner 50 is in the insertion area PA, the wire cleaner 50 would obstruct the discharging action between the charging wire 40 and the metallic mesh 42. Faulty printing might occur as a result. Therefore, as shown in FIG. 5, when the wire cleaner 50 is fitted to the pre-charger 16, the photosensitive area X of the photosensitive drum 14 would become an unused area. Or in some cases, faulty printing might occur even within the area X.

According to the present invention, as the wire cleaner 50 can be positioned in the step-aside position (FIG. 11) in which the cleaning members 62 is away from the charging wire 40, the discharging action between the charging wire 40 and the metallic mesh 42 is not obstructed. Therefore, the area X can be used as a normal photosensitive area, and no faulty printing occurs within the area X, either.

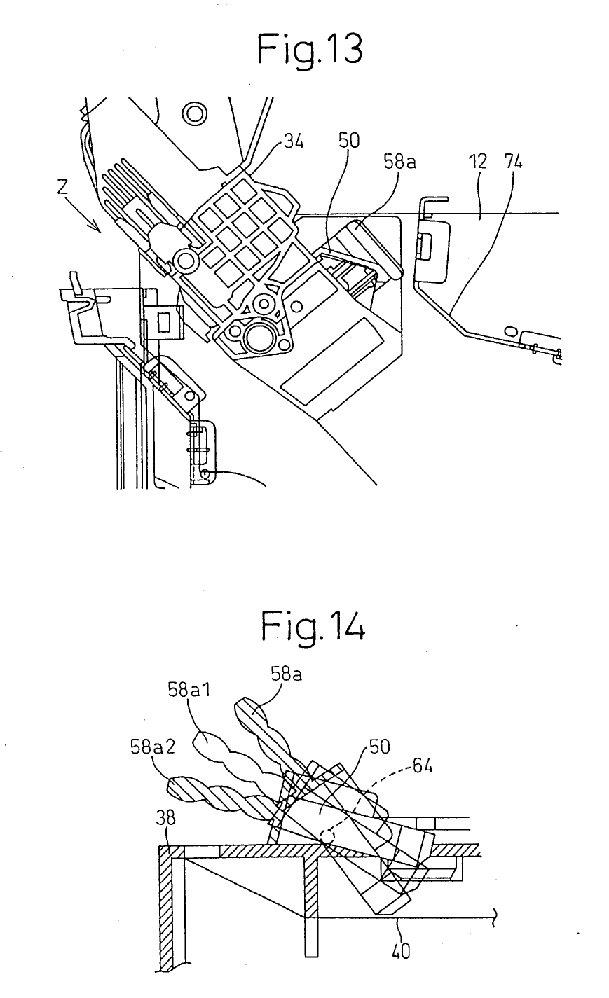

FIG. 13 and FIG. 14 illustrate how the printing unit 34 is inserted into the frame 12 of the device. The frame 12 of the device has an insertion guide 74, which guides the printing unit 34 to be inserted into the frame 12 of the device in an oblique direction indicated by arrow Z. The insertion guide 74 has a vertical portion and an inclined portion. The printing unit 34 is arranged to be inserted into the frame 12 of the device with the wire cleaner 50 being in its step-aside position.

However, if it is tried to insert the printing unit 34 into the frame 12 of the device in a state in which the wire cleaner 50 is not in its step-aside position, for instance when it is in its regular position, the protruding knob 58a of the wire cleaner 50 will hit against the vertical portion of the insertion guide 74, thereby preventing the printing unit 34 from being inserted into the frame 12 of the device.

Further, if the printing unit 34 is to be inserted into the frame 12 of the device in a state in which the wire cleaner 50 is in its step-aside position, even if the wire cleaner 50 is not fully in its step-aside position, the printing unit 34 can be inserted into the frame 12 of the device while the wire cleaner 50 is automatically rotated. Thus the knob 58a of the wire cleaner 50 shown in FIG. 14 is in an incomplete step-aside position. If the printing unit 34 is to be inserted into the frame 12 of the device in a state in which the knob 58a of the wire cleaner 50 is in an incomplete step-aside position, the knob 58a of the wire cleaner 50 will hit against the vertical portion of the insertion guide 74 to be rotated (58a1), and further to be rotated when it hits against the inclined portion of the insertion guide 74 (58a2), with the wire cleaner 50 going into a substantially horizontal step-aside position. In this way, the wire cleaner 50 provided with the knob 58a can be kept fitted to the pre-charger 16.

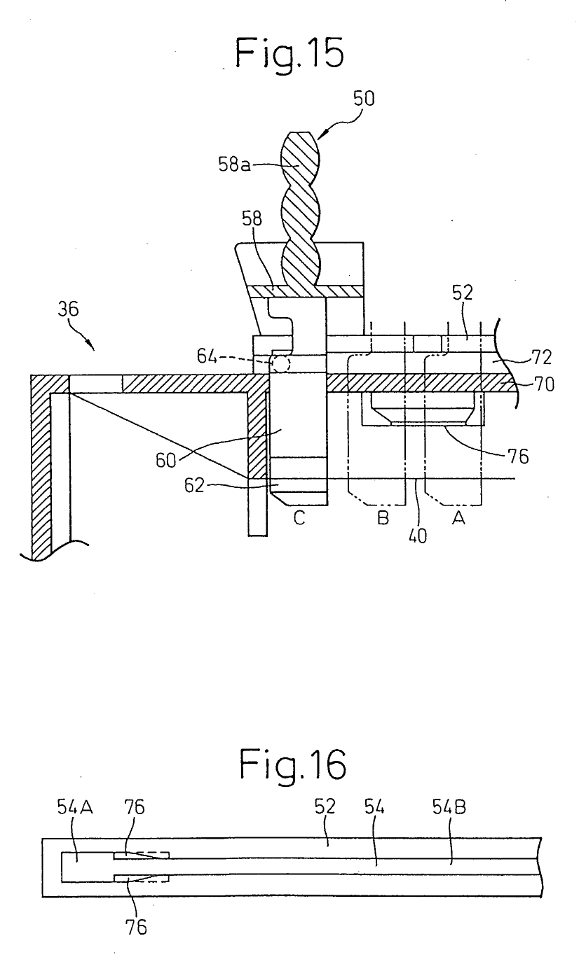

FIG. 15 shows an enlarged sectional view of part of FIGS. 10 and 11, and FIG. 16, a plan of the cleaner guide 52 and auxiliary guides 76 of FIG. 4. Referring to FIGS. 10, 11 and 15, the auxiliary guides 76 are arranged underneath the cleaner guide 52, and extend from the vicinity of the boundary between the wider guide portion 54A and the narrower guide portion 54B of the slit 54 in the cleaner guide 52 towards midway on the wider guide portion 54A.

It is preferable for the cleaning members 62 at the tips of the legs 60 of the wire cleaner 50 to be open relative to each other as shown in FIG. 11 and FIG. 12 when the wire cleaner 50 is in its step-aside position, because, if the cleaning members 62 are open relative to each other when not in use, their wear can be reduced. In order to keep the cleaning members 62 open relative to each other when the wire cleaner 50 is in its step-aside position, the wider guide portion 54A of the slit 54 in the cleaner guide 52 should be relatively long. However, when the legs 60 of the cleaning members 62 are positioned in the wider guide portion 54A as shown in FIG. 8, since the cleaning members 62 are not in contact with the charging wire 40 and accordingly no cleaning is performed, the uncleaned portion of the charging wire 40 will increase if the wider guide portion 54A is made longer.

Therefore, by securing a certain length for the wider guide portion 54A of the slit 54 in the cleaner guide 52 and providing the auxiliary guides 76, the length of the narrower guide portion 54B of the slit 54 in the cleaner guide 52 is increased. Thus, referring to FIG. 15, when the legs 60 of the wire cleaner 50 are in position A or position B, the cleaning members 62 are in contact with the charging wire 40, but when the legs 60 of the wire cleaner 50 are in position C, the cleaning members 62 are not in contact with the charging wire 40, and the wire cleaner 50 is rotated from its regular position to step-aside position in position C. In this process, although the legs 60 of the wire cleaner 50 are once closed when they pass the auxiliary guides 76, they are opened again when they pass the wider guide portion 54A of the slit 54 in the cleaner guide 52 and, as shown in FIG. 11 and FIG. 12, the cleaning members 62 at the tips of the legs 60 of the wire cleaner 50 are opened relative to each other.

As hitherto described, according to the present invention, the charging wire can be cleaned easily and thoroughly, thereby facilitating normal printing. Furthermore, the wire cleaner is assembled with the image forming device and can be easily operated.

What is claimed is:

1. An image forming device comprising a frame, a photosensitive drum, a charger including a charging wire for electrically charging the photosensitive drum, an optical head for forming an electrostatic latent image on the photosensitive drum, a developer for developing the electrostatic latent image into a toner image, and a wire cleaner for cleaning the charging wire, wherein
the wire cleaner is provided with a pair of cleaning members disposed to be able to squeeze the charging wire between them, and the wire cleaner is fitted to the charger to enable the cleaning members to move between a regular position in which they are placed on two sides of the charging wire and a step-aside position in which the cleaning members are farther from the charging wire than in the regular position.

2. The image forming device according to claim 1, wherein the frame has an insertion area in which the wire cleaner is inserted into the frame and a shifting area in which the wire cleaner can shift along the charging wire, the cleaning members are movable between a first position in which they are away from the charging wire and a second position in which they come into contact with the charging wire, and the cleaning members are in the first position when the wire cleaner is in the insertion area and in the second position when the wire cleaner is in the shifting area.

3. The image forming device according to claim 2, wherein the wire cleaner can shift between the regular position and the step-aside position when the wire cleaner is in the insertion area.

4. The image forming device according to claim 3, wherein the wire cleaner is substantially vertical to charging wire when the wire cleaner is in the regular position and substantially parallel to the charging wire when it is in the step-aside position.

5. The image forming device according to claim 4, wherein the photosensitive drum, the charger and the developer are integrated as a printing unit, and the frame has guide portions which guide the wire cleaner to be able to be displaced from the regular position to the step-aside position when the printing unit is inserted into the frame.
